(19) United States
(12) Patent Application Publication
(10) Pub. No.: US 2026/0328265 A1
(43) Pub. Date: Oct. 22, 2026

(54) ROTOR SHAFT WITH TORSIONAL COMPLIANCE

(71) Applicant: American Axle & Manufacturing, Inc., Detroit, MI (US)

(72) Inventors: Zhaohui Sun, Rochester Hills, MI (US); Paul J. Valente, Berkley, MI (US); James P. Downs, South Lyon, MI (US)

(21) Appl. No.: 19/185,373

(22) Filed: Apr. 22, 2025

(51) Int. Cl. F16H 1/20; F16D 1/116; F16D 3/12; F16H 57/021; F16H 57/04; H02K 7/00; H02K 7/116; H02K 9/19; F16H 57/02

(52) U.S. Cl. CPC F16H 1/20; F16D 1/116; F16D 3/12; F16H 57/021; F16H 57/0412; F16H 57/0416; F16H 57/0476; H02K 7/003; H02K 7/116; H02K 9/19; F16H 2057/02034; F16H 2057/02043

(57) ABSTRACT

An electric motor drive system for a vehicle includes an electric motor having a stator and a rotor assembly. The rotor assembly has a rotor shaft system that includes a hollow, elongated rotor shaft and an attached elongated gear shaft. The rotor shaft is configured to rotate about an axis and includes a rotor shaft sidewall defining an interior. The gear shaft is concentrically received within the interior and has a gear shaft proximal end and a gear shaft distal end at which end resides a drive gear. The gear shaft proximal end is fixedly coupled to the rotor shaft such that the rotor shaft and the gear shaft rotate together. The gear shaft can be fixedly coupled to the rotor shaft proximal end. A gearbox having an input is configured for engagement with the drive gear.

### FIELD

The present disclosure relates generally to rotating electrical machines and more particularly to a rotor shaft with torsional compliance.

### BACKGROUND

This section provides background information related to the present disclosure which is not necessarily prior art.

There is an increasing interest in the electrification of vehicle drivelines of the type including an electric motor having a rotor shaft that delivers a rotary output (i.e., torque) to an attached gearbox by way of, for example, a drive gear. The drive gear may be part of the rotor shaft and in mesh with one or more input gear(s) of the gearbox. It is desirable to control gear mesh force levels and one input factor influencing such levels involves the torsional compliance of the rotor shaft that typically drives the drive gear. It would be useful to increase the torsional compliance of the rotor shaft, which can result in a decrease of gear mesh force levels with a given gear mesh transmission error (TE).

### SUMMARY

In accordance with one implementation, an electric motor drive system is provided that includes an electric motor having a stator and a rotor assembly. The rotor assembly has a rotor shaft system that includes a hollow rotor shaft and a gear shaft. The rotor shaft extends along and is configured to rotate about an axis. The rotor shaft includes a rotor shaft sidewall that defines an interior. The gear shaft is concentrically received within the interior of the rotor shaft and has a gear shaft proximal end and a gear shaft distal end. The gear shaft has a drive gear disposed at its distal end. The gear shaft proximal end is fixedly coupled to the rotor shaft such that the rotor shaft and the gear shaft rotate together. The rotor shaft system has an increased length due to the introduction of the gear shaft, which increases torsional compliance.

In an implementation, the gear shaft proximal end is fixedly mounted to the rotor shaft proximal end to thereby nest the gear shaft in the rotor shaft so as to not increase a packaging length while still increasing an operating length.

In a further implementation, the electric motor drive system further includes a gearbox having an input (e.g., one or more input gears) configured for engagement with the drive gear, wherein the gearbox further includes an output, which can be used for vehicle propulsion.

Further implementations are disclosed that exhibit increased rotor shaft torsional compliance.

Further areas of applicability will become apparent from the description provided herein. The description and specific examples in this summary are intended from purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an isometric view depicting an exemplary electric motor drive system, in an implementation;

FIG. 2 is a cross-sectional view of the electric motor drive system of FIG. 1 taken substantially along lines 2-2, depicting a rotor assembly having a rotor shaft system;

FIG. 3 is an enlarged cross-sectional view of a portion of the rotor shaft system of FIG. 2 with portions omitted for clarity;

FIG. 4 is an isometric view of the rotor assembly of FIG. 2;

FIG. 5 is a cross-sectional view showing the proximal end of the rotor assembly of FIG. 2, in an implementation;

FIG. 6 is an isometric view depicting an axial end of the rotor assembly of FIG. 2, with an end cap omitted for clarity;

FIG. 7 is a cross-sectional view showing the proximal end of the rotor assembly of FIG. 2, including an air vent passageway, in an implementation;

FIG. 8 is an isometric view of the end cap of FIG. 7;

FIG. 9 is an exploded, isometric view of the rotor assembly, in an implementation;

FIGS. 10-11 are cross-sectional views of an oil circulation-based cooling system at rotor assembly distal and proximal ends, respectively;

FIG. 12 is a cross-sectional view of the rotor assembly of FIG. 2 showing the flow of torque to the drive gear;

FIG. 13 is a cross-sectional view of a rotor assembly for an electric motor having an alternate rotor shaft system, in an implementation;

FIGS. 14-15 are cross-sectional views of the rotor shaft system of FIG. 13 in initial and final stages of assembly, respectively;

FIG. 16 is an enlarged, cross-sectional view of the proximal end of the rotor shaft system of FIG. 13;

FIG. 17 is a cross-sectional view of the rotor shaft system of FIG. 13 taken along a different section line to show an oil passage;

FIG. 18 is a cross-sectional view of a further alternate rotor shaft system, in an implementation;

FIG. 19 is a cross-sectional view of the rotor shaft system of FIG. 18 showing a retaining ring;

FIG. 20 is a cross-sectional view of a still further alternate rotor shaft system, in an implementation;

FIG. 21 is a cross-sectional view of a yet further alternate rotor shaft system, in an implementation;

FIG. 22 is a cross-sectional view of a still yet further alternate rotor shaft system employing elastomeric material, in an implementation;

FIG. 23 is a cross-sectional view of another alternate rotor shaft system including a helical shaped insert of elastomeric material, in an implementation;

FIG. 24 is a cross-sectional view of yet another alternate rotor shaft system including a starburst-shaped insert of elastomeric material, in an implementation;

FIG. 25 is a diagrammatic, cross-sectional view of a rotor assembly for an electric motor having a still yet another rotor shaft system including a reduced outside diameter stub shaft; and

FIG. 26-27 are plots showing reductions in ERP compared to baseline levels for extended shaft length and reduced shaft outside diameter approaches, respectively.

Corresponding reference numerals indicate corresponding parts throughout the several views of the drawings.

### DETAILED DESCRIPTION

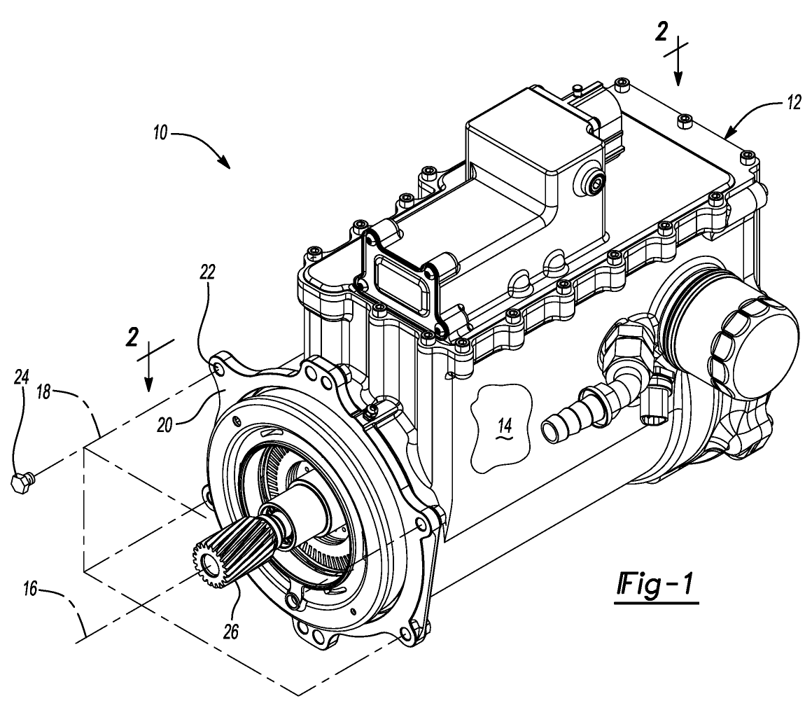

FIG. 1 is an isometric view depicting an exemplary electric motor drive system in accordance with the teachings of the present disclosure, generally indicated by reference numeral 10. The system 10 is configured to provide propulsion drive for a vehicle (not shown in FIG. 1) in one implementation and may be adapted to a variety of platforms, such as a partial or a fully electrified vehicle powertrain. The system 10 incorporates a configuration that increases a torsional compliance of a rotor shaft, which can desirably decrease gear mesh force levels. In implementations, the configuration involves extending the shaft length and/or reducing the shaft diameter between the rotor and a drive gear so that an increase of torsional compliance is added to the system 10. This will cause a decrease in gear mesh force levels with a given gear mesh transmission error (TE). In other words, a significant amount of torsional compliance can be added to the system, which can help reduce the gear mesh dynamic force and therefore responses, such as vibration responses of the assembly housing and corresponding sound radiation.

One approach described herein involves introducing a separate shaft (i.e., a “gear shaft”) for the drive gear that is contained in the interior of, and is fixedly coupled to, the existing rotor shaft. The connection is made at a far end (i.e., opposite end to the drive gear) such that the gear shaft is nested in the rotor shaft, which increases the operating length between the rotor and the drive gear but does not significantly increase the overall package length or footprint.

Another approach described herein involves reducing the shaft diameter by introducing a stub shaft between the rotor shaft and the drive gear where the stub shaft has a first diameter at one end to match that of the rotor shaft but then transitions to a smaller diameter at the other end where the drive gear is disposed. This configuration also adds torsional compliance to the system, thereby reducing the gear mesh dynamic force and responses.

The various implementations according to these approaches will be referred to as a rotor shaft system that includes the rotor shaft, a gear shaft or stub shaft as the case may be, as well as other components as will be described and illustrated in detail hereinafter. In the implementations, the gear shaft or stub shaft rotates with the rotor shaft and with increased torsional compliance.

With continued reference to FIG. 1, the electric motor drive system 10 includes a housing 12, an electric motor 14 received in the housing 12 that develops a rotary output about an axis 16, and a gearbox 18 (shown in phantom line). The housing 12 includes a flange 20 having a plurality of holes 22 for the attachment of the gearbox 18, which attachment may be achieved through the use of fasteners 24 (one shown in FIG. 1). The rotary output of the motor 14 is delivered by way of a drive gear 26 extending from housing 12. It should be understood that the type of drive gear 26 shown is exemplary only and not limiting in nature. Different shapes may be used for transmitting rotational force (torque), such as a spline.

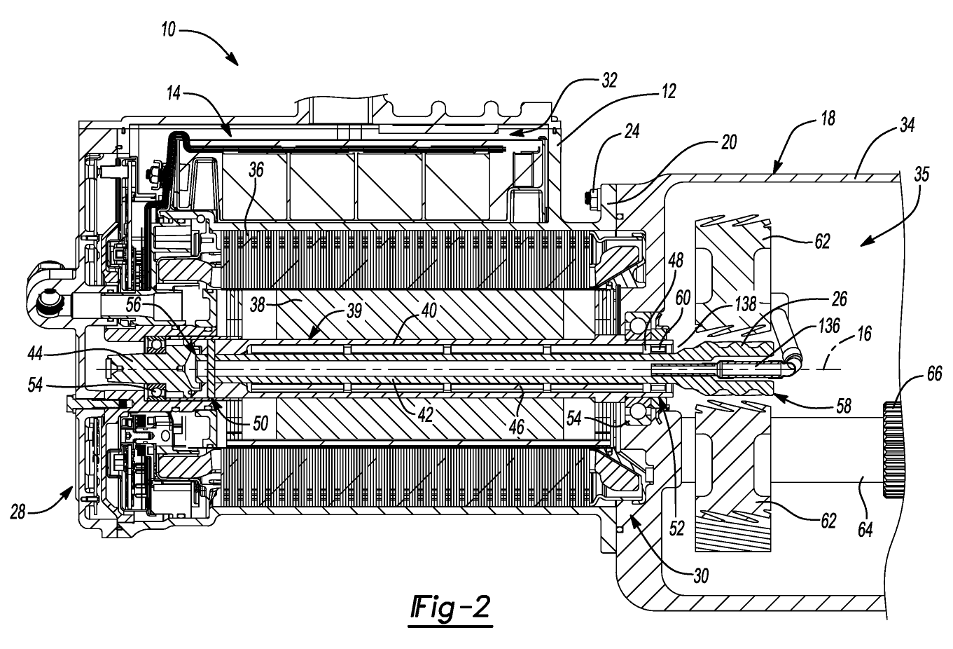

FIG. 2 is a cross-sectional view of the electric motor drive system 10 of FIG. 1 taken substantially along lines 2-2. The housing 12 generally extends between a proximal end 28 and a distal end 30 and defines a cavity 32. The gearbox 18 includes a gearbox housing 34 that defines an enclosure 35.

The electric motor 14 can be received in the cavity 32 and includes a stator 36 and a rotor assembly 38 comprising a rotor shaft system 39 having a rotor shaft 40, a gear shaft 42, and an end cap 44. The illustrated implementation features an oil circulation-based rotor shaft cooling system that includes heat sink(s) 46 for this purpose. While the cooling system will be described in greater detail below, the electric motor 14 as shown in FIG. 1 includes an oil inlet port 136 (at the distal end opening of the gear shaft 42) and an oil outlet port 138 (at the distal end opening of the rotor shaft 40). The electric motor 14 can be any type of electric motor, such as an AC induction motor or a permanent magnet motor. The stator 36 can be fixedly mounted to the housing 12 and can be disposed circumferentially about at least a portion of the rotor assembly 38. More generally, the electric motor 14 may be configured to receive electrical current from an inverter (not shown) to induce rotational displacement of the rotor shaft 40 relative to the stator 36, such as a permanent magnet synchronous machine. However, other implementations of electric motors as they can be used to propel a vehicle are possible.

The rotor shaft 40 is hollow, which defines an interior 48. The rotor shaft 40 extends along the axis 16 between a rotor shaft proximal end 50 and a rotor shaft distal end 52. The rotor shaft 40 is mounted to the housing 12 for rotation about the axis 16 by way of a pair of bearings 54. The rotor shaft 40 rotates with the rotor assembly 38. A bushing 60 is provided at the distal end 52 that is configured to maintain the concentric positioning of the gear shaft 42 relative to the rotor shaft 40. It should be understood that item 60 may comprise a plain bearing, a bushing, or a bearing, and will be hereinafter referred to, without loss of generality, as the bushing 60. The bushing 60—while generally closing the rotor shaft opening at the distal end 52, has features that allow oil as part of the cooling system to pass therethrough. The bushing 60 may be pressed into the rotor shaft inside diameter and closely pilots the gear shaft 42. The gear shaft 42 can freely rotate in the bushing 60. In an implementation, the bushing 60 may be made out of any suitable materials, including but not limited to bronze, oil impregnated bronze, or the like. The rotor shaft 40 may be shaped generally as a hollow right cylinder although it should be appreciated that this is exemplary only and not limiting in nature.

The gear shaft 42 is concentrically received within the interior 48 and also extends along the axis 16 between a gear shaft proximal end 56 and a gear shaft distal end 58. The drive gear 26 is disposed at the distal end 58. The proximal end 56 is fixedly coupled to the rotor shaft 40 such that the gear shaft 42 and the rotor shaft 40 rotate together. In the implementation of FIG. 2, the gear shaft 42 is fixedly connected at the proximal end 50 so that the gear shaft 42 is nearly completely nested within the rotor shaft 40. The gear shaft 42 may be shaped generally as a hollow right cylinder although it should be appreciated that this is exemplary only and not limiting in nature. Additionally, the gear shaft 42 may be unitary as shown, although this is exemplary as well and not limiting as well. The rotor shaft system 39, by virtue of at least the introduction of an additional shaft (i.e., the gear shaft 42), exhibits an increased shaft length from the rotor to the drive gear 26 thereby increasing torsional compliance.

The gearbox 18 can include a transmission employing a variety of moving components such as sprockets, chains, meshing gears, and combinations thereof to implement a desired output speed and torque performance. In the illustrated example, the gearbox 18 can include one or more input gear(s) 62, an output shaft 64, and an output gear 66, which are all received in the interior 35. The drive gear 26 extends axially into the interior 35 when the gearbox 18 is mounted to the housing 12 so as to place the drive gear 26 in mesh with the input gear(s) 62. The output shaft 64 is coupled to and arranged to be driven by the input gear(s) 62. The output shaft 64 may in turn may be coupled to the output gear 66. The output gear 66 provides a rotary output that may be coupled to one or more driveline component as known in the art in order to deliver rotary power to one or more wheels of a vehicle (not shown). It should be understood that this description of the transmission is exemplary only and not limiting in nature. Additionally, other applications for such rotary power are possible.

FIG. 3 is an enlarged cross-sectional view of the rotor shaft system 39 of FIG. 2, with the heat sinks 46 omitted for clarity. The rotor shaft 40 is as mentioned above a hollow shaft with openings at both axial ends and includes a sidewall 68 of predetermined thickness with a generally circular cross-section. The sidewall 68 defines the interior 48. The sidewall 68 includes a rotor shaft outside diameter surface 70 and a rotor shaft inside diameter surface 72. In embodiments, the sidewall 68 thickness may be varied between about 1 mm and 10 mm, although it should be understood that these values are exemplary only and not limiting in nature. The gear shaft 42 may also be a hollow shaft with openings at both axial ends and includes a sidewall 74 of predetermined thickness with a generally circular cross-section. The sidewall 74 defines an inner cavity 76. The sidewall 74 includes a gear shaft outside diameter surface 78 and a gear shaft inside diameter surface 80. In implementations, the rotor shaft 40 and the gear shaft 42 may comprise steel or steel alloy material.

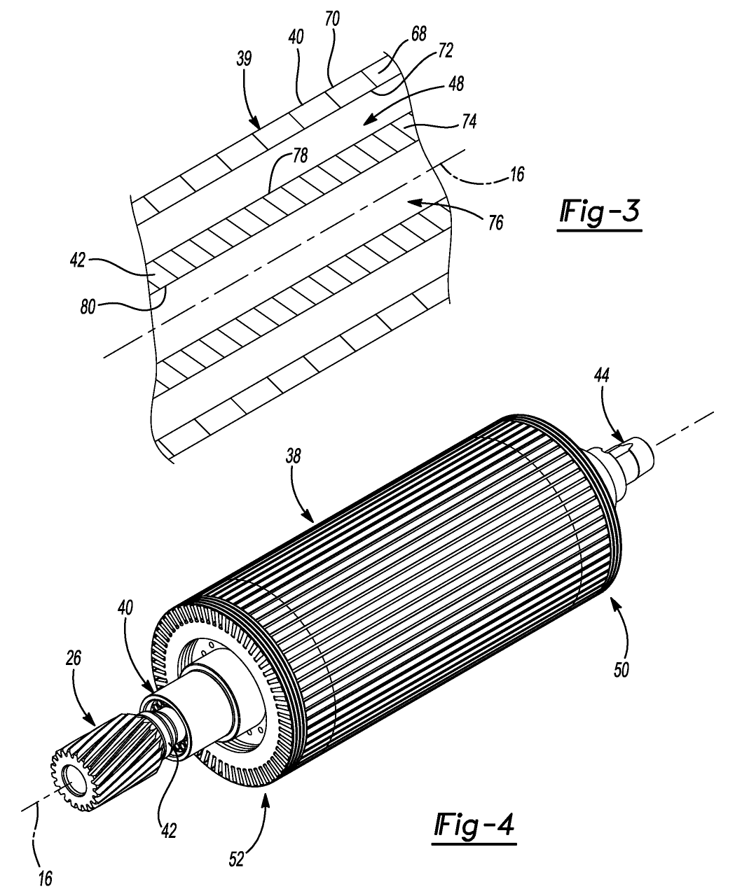

FIG. 4 is an isometric view of the rotor assembly 38 of FIG. 2. The rotor assembly 38 is generally cylindrical in shape and axially-extends along the axis 16 between the proximal end 50 and the distal end 52. The rotor shaft 40, the gear shaft 42 including the drive gear 26, and the end cap 44 are also shown.

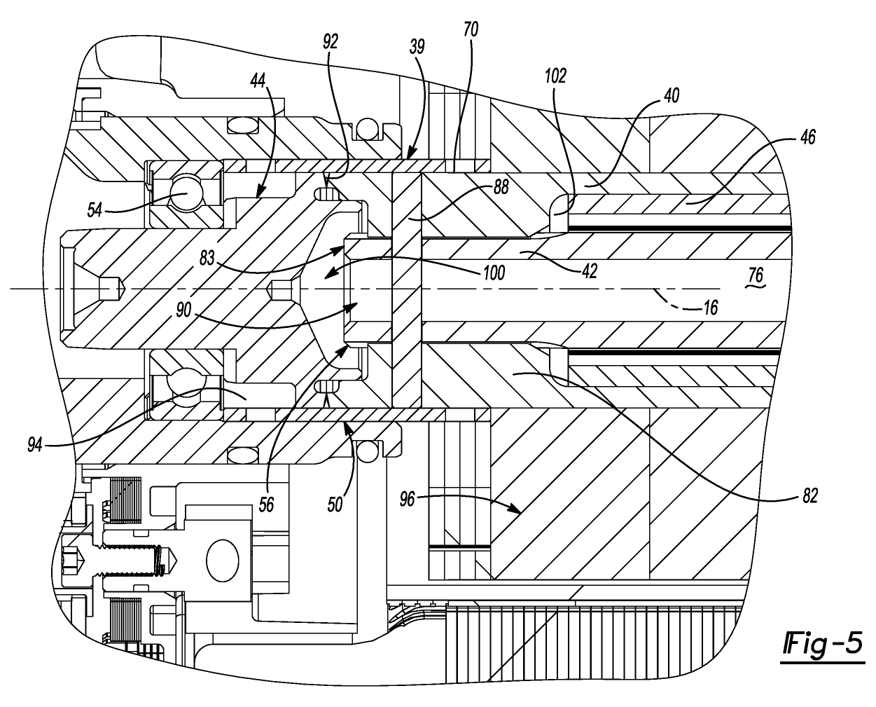

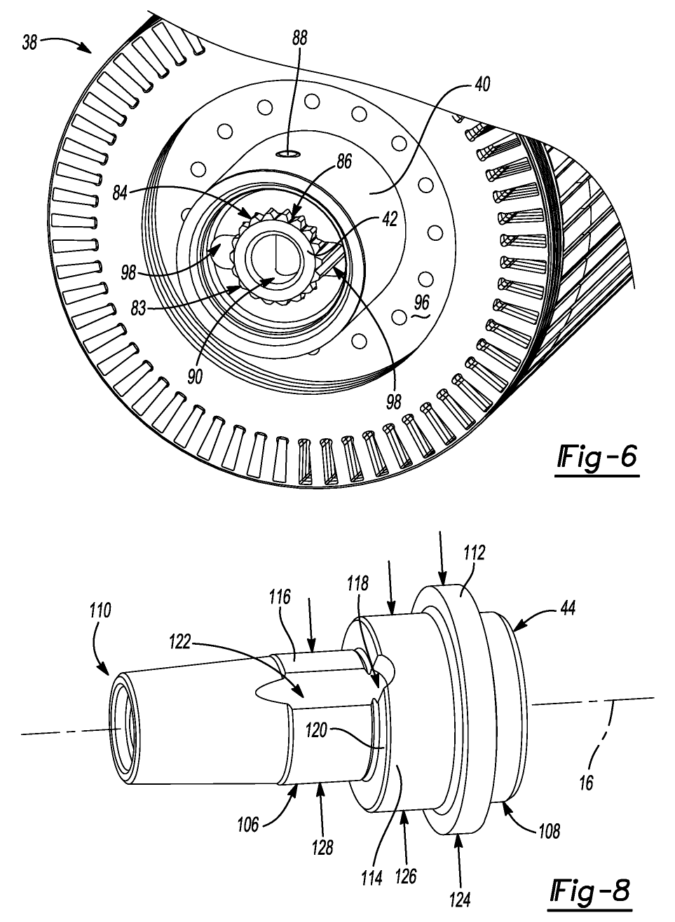

FIGS. 5-6 are cross-sectional and isometric views, respectively, showing the proximal end of the rotor shaft system 39 of FIG. 2. The rotor shaft 40, in the illustrated implementation, has a reduced inside diameter portion 82 sized to accommodate the gear shaft 42. The proximal end 56 of the gear shaft 42 is fixedly connected to the proximal end 50 of the rotor shaft 40 by way of a splined connection 83. The splined connection 83 includes, on the proximal end 56, a plurality of splines 84 formed on the outside diameter surface 78 (best shown in FIG. 6). The reduced diameter portion 82 has a corresponding plurality of grooves 86 (best shown in FIG. 6), wherein each spline 84 resides in a corresponding groove to form the splined connection 83.

A dowel pin 88 extends transversely of the axis 16 through the rotor shaft 40 and the gear shaft 42 at the respective proximal ends thereof, as illustrated. The dowel pin 88 may be press fit (in an implementation) into the rotor shaft 40 and reacts axial thrust of the gear shaft 42. The press-fit also seals oil. The dowel pin 88 may be a clearance fit with respect to the gear shaft 42.

The interior 48 of the rotor shaft 40 includes an opening 90 at the proximal end 50 and another opening at the distal end 52. The end cap 44 is configured to close the opening 90. The end cap 44 may be welded to the rotor shaft 40, as shown at 92. In an alternate implementation, the end cap 44 may be press fit to the rotor shaft 40. In a still further implementation, the end cap 44 may be both press fit and welded to the rotor shaft 40. The end cap 44 comprises non-magnetic material as it holds a magnet (not specifically shown) that is epoxied in or mechanically fastened thereto for those implementations using a Tunnel Magnetoresistance (TMR) speed sensor, as seen by reference to United States application no. 17/880,746 filed Aug. 4, 2022 (now U.S. pat. no. 11,863,046), the disclosure of which is hereby incorporated by reference as though fully set forth in detail herein. In alternate implementations where a TMR speed sensor is not used, such as when a resolver or an encoder type speed sensor is used, such a magnet would not be required. It should be appreciated that the end cap 44 should be relatively invisible to the flux of the magnet for the magnetic field to remain strong.

A sleeve 94 is disposed on the outside diameter surface 70 of the rotor shaft 40 at the proximal end 50 thereof. The sleeve 94 is configured to retain the dowel pin 88 in the rotor shaft 40, especially at relatively high rotational speeds of the rotor assembly 38. The sleeve 94 is axially trapped by ball bearing 54 and rotor laminations stack 96. In an implementation, the sleeve 94 may comprise steel, nonferrous metals, plastic, or composite materials.

In an implementation where the end cap 44 is welded to the rotor shaft 40, the end cap 44 is adapted to take the axial thrust of the gear shaft 42 in one direction (i.e., in the proximal direction). The splined connection 83 reacts the torque of the gear shaft 42. It should be appreciated that the dowel pin 88 is adapted to react both torque and thrust. In an alternate implementation, the gear shaft 42 can have a journal fit to the rotor shaft 40. The rotor shaft system 39 thus further includes, in the illustrated implementation, the splined connection 83, the dowel pin 88, and the sleeve 94.

FIG. 6 is an isometric view of an axial end of the rotor assembly 38, with the end cap 44 omitted from FIG. 6 for clarity. The opening 90 is in fluid communication with the inner cavity 76, which in turn is in fluid communication with the oil inlet port 136 (FIG. 1). The rotor shaft 40 includes at least one passage 98 that extends through the reduced inside diameter portion 82 and opens up towards the interior 48 of the rotor shaft 40. In the illustrated implementation, the rotor shaft 40 includes two passages 98.

Returning to FIG. 5, the passages 98 are configured to fluidly couple oil flowing out of the opening 90 and into a duct 100 formed in the end cap 44, to an annular space 102 defined in the interior 48. The heat sinks 46 reside in the annular space 102.

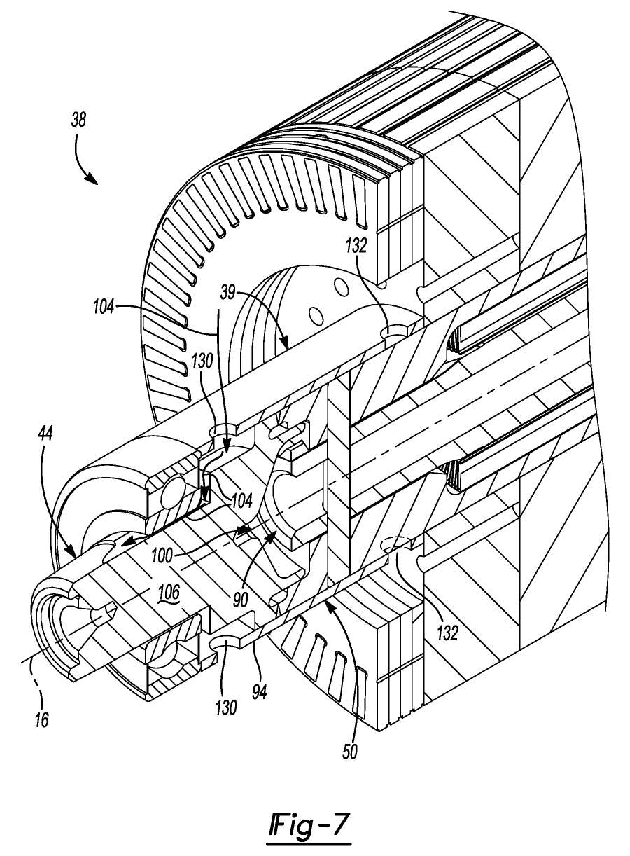

FIG. 7 is a cross-sectional view of the proximal end of the rotor assembly 38. In addition to oil circulation-based cooling, the rotor assembly 38 also includes air circulation-based cooling functionality. In particular, the end cap 44, the bearing 54, and the sleeve 94 have structural features that cooperate to establish an air passageway 104 that allows air to vent from an area proximate the rotor assembly 38 to an exterior thereof.

FIG. 8 is an isometric view of the end cap 44, which includes an annular body 106 having a first end 108 and a second end 110 that is axially opposite the first end 108. The end cap 44 further includes a circumferential surface 112, an annular surface 114 extending in an axially proximal direction relative to the circumferential surface 112, and a bearing surface or bearing journal 116 extending in the axially proximal direction relative to annular surface 114. The end cap 44 further includes a pair of notches 118 formed in a bearing shoulder 120, although one of the notches 118 is not visible in FIG. 8 and is located approximately 180 degrees offset from the notch 118 that is visible in FIG. 8. The end cap 44 further includes a pair of flat portions 122 on the bearing surface 116, although one of the flats 122 is not visible in FIG. 8 and is located approximately 180 degrees offset from the flat 122 that is visible in FIG. 8.

Referring now to FIGS. 7-8, the first end 108 confronts the first opening 90. The circumferential surface 112 extends radially outwardly a first outside diameter 124 (relative to the axis 16) to engage the sleeve 94. The annular surface 114 extends radially outwardly a second outside diameter 126 (relative to the axis 16) wherein the second outside diameter 126 is less than the first outside diameter 124. The bearing surface 116 extends radially outwardly a third outside diameter 128 (relative to the axis 16) that is less than the second outside diameter 126.

The sleeve 94 axially extends over the circumferential surface 112 and engages the circumferential surface 112. The sleeve 94 also axially extends over the annular surface 114. An open volume is created between the surface 114 and the sleeve 94. The sleeve 94 includes a first set of through-holes 130 located such that the holes 130 reside over the annular surface 114. The holes 130 are symmetric for balance (i.e., while rotating at very high speeds, the absence of mass where the holes are formed are balanced). In an implementation, the sleeve 94 may include a further, second set of through-holes 132 that match the first set 130 in size and location relative to the sleeve edge such that no matter which axial end of the sleeve 94 is installed in the distal-facing direction, the resultant assembly will be the same (i.e., error proofing the manufacturing). The air passageway 104 formed vents air outside of the sleeve 94 and adjacent the rotor stack to an exterior of the electric motor 14. The air passageway 104 includes a path extending through the through-holes 130, over the annular surface 114, through the notches 118, and along a space overlying the flats 122 to the exterior.

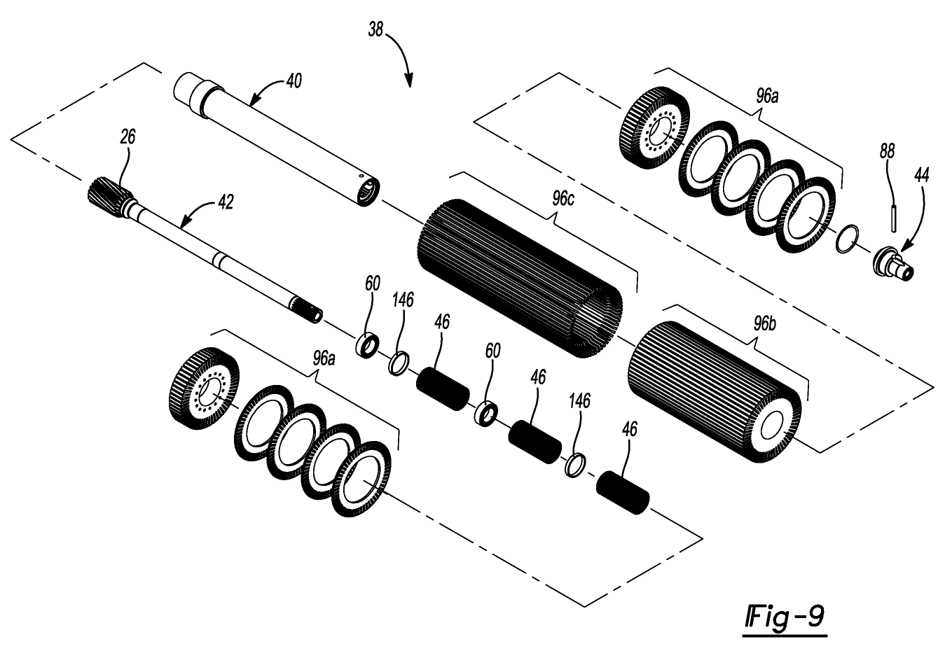

FIG. 9 is an exploded view of the rotor assembly 38, in an implementation. As illustrated, the rotor shaft 40 and gear shaft 42 are generally cylindrical shaped, annular bodies. The rotor lamination stack 96 may include sub-portions, including end ring assemblies 96a, laminated rotor core 96b, and rotor windings and/or conductors 96c.

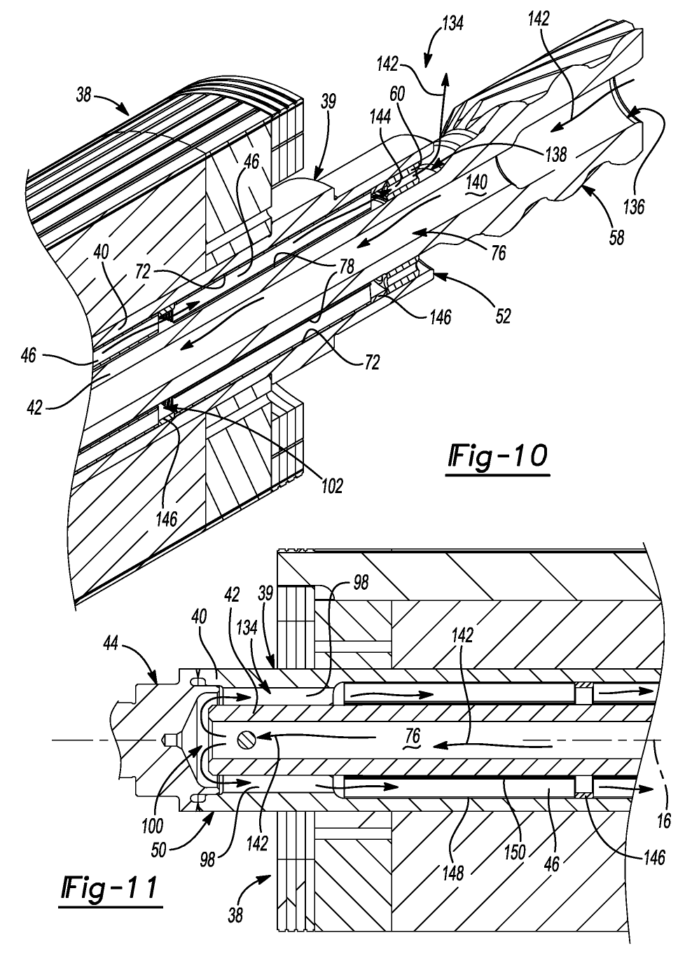

FIGS. 10-11 are cross-sectional views of the oil circulation-based cooling system 134, at the distal and proximal ends of the rotor and gear shafts, respectively. The cooling system 134 is configured to draw heat away from the internal portions of the electric motor 14 including the rotor assembly 38. FIG. 10 shows a first portion of the cooling system 134 where the inlet and outlet ports 136, 138 are located while FIG. 11 show a second portion involving a flow path that returns oil introduced at the inlet port 136 back to the outlet port 138.

As shown in FIG. 10, the inlet port 136 is formed at the distal end opening of the gear shaft 42 and is in fluid communication with the inner cavity 76. The outlet port 138 is formed at the distal end opening of the rotor shaft 40 and is in fluid communication with the annular space 102. The annular space 102 is defined between the rotor shaft inside diameter 72 and the gear shaft outer surface 78. The rotor shaft system 39 includes a cooling channel 140 that fluidly couples the inlet port 136 and the outlet port 138 in a coolant flow path 142. The coolant flow path 142 is indicated by several curvy, single-headed arrow lines in FIGS. 10-11 with only one such line being identified with the reference numeral 142 in each Figure for clarity. A pump (not shown) introduces the oil into the inlet port 136, which flows through the cooling channel 140 along the coolant flow path 142 and is dispelled through the outlet port 138.

The cooling channel 140 includes the inner cavity 76 in the gear shaft 42, the duct 100 formed in the end cap 44 (shown in FIG. 11), the passages 98 (shown in FIG. 11), and the annular space 102 in which the heat sinks 46 reside. The passages 98 fluidly couple the annular space 102 with the inner cavity 76 through the duct 100. The bushing 60 includes a plurality of axially-extending passageways 144 therethrough that fluidly couple the annular space 102 to the outlet port 138, which allows the oil to flow freely out of the distal end of the rotor shaft 40.

The one or more heat sinks 46 can be disposed linearly along the axis 16 and reside within the annular space 102. The plurality of discrete heat sinks 46 may be separated by annular spacers 146 that are also disposed at points along the axis 16 in the annular space 102.

Referring to FIG. 11, in one implementation, the heat sinks 46 are arranged to be in intimate contact (shown at 148) with the inside diameter surface 72 of the rotor shaft 40. Such contact may be achieved by an interference fit or by a bonding technique such as but not limited to soldering or furnace brazing. The heat sinks 46 may be of any design, such as the folded-fin style as illustrated. In alternate implementations, there may be greater or fewer number of heat sinks 46. In further alternative implementations, the folded fin heat sinks 46 may be plain or have other features such as lances, louvers, ruffles, or other heat sink features known in the art. The heat sinks 46 may be spaced from the outer surface 78 of the gear shaft 42 by a clearance 150.

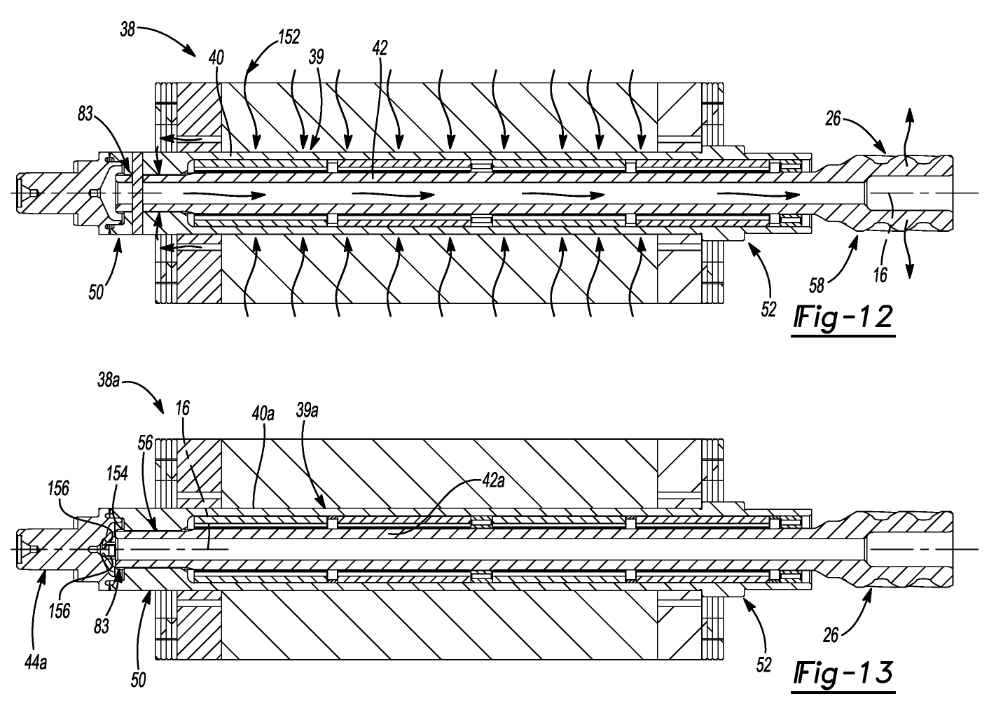

FIG. 12 is a cross-sectional view of the rotor assembly 38 showing a torque flow 152 from origination to delivery and indicated by curvy, single-headed arrow lines with only one such line being identified with the reference numeral 152 for clarity. The rotor shaft 40 experiences torque directly along a significant portion of its axial length between the proximal end 50 and the distal end 52. The extreme proximal ends of both the rotor shaft 40 and gear shaft 42 are connected by way of the splined connection 83, dowel pin, and end cap 44. The torque 152 then flows the length of the gear shaft 46 to the drive gear 26 at the gear shaft distal end 58. The additional drive length contributed by the gear shaft 42 increases the torsional compliance of the rotor shaft system 39 (i.e., from the rotor to the drive gear).

FIGS. 13-17 illustrate various views of a rotor assembly 38a that includes an alternate implementation of a rotor shaft system designated 39a. Unless otherwise described and/or illustrated, the rotor shaft system 39a may be the same or similar as the rotor shaft system 39 to the extent that the same or similar reference numerals (i.e., differing by only a suffix—a letter) identify the same or similar components in the various views. The rotor shaft system 39a may be used in the electric motor 14 of FIG. 2.

FIG. 13 is a cross-sectional view of the rotor assembly 38a. In the rotor shaft system 39a, the connection of the gear shaft 42a to the rotor shaft 40a differs from the implementation of FIGS. 2-12 in that a retaining ring 154 is used instead of the dowel pin 88/sleeve 94, with changes also made to the rotor shaft 40a, the gear shaft 42a, and the end cap 44a as described and illustrated herein. The spline connection 83 as described above in this implementation may be used to react gear shaft rotational forces.

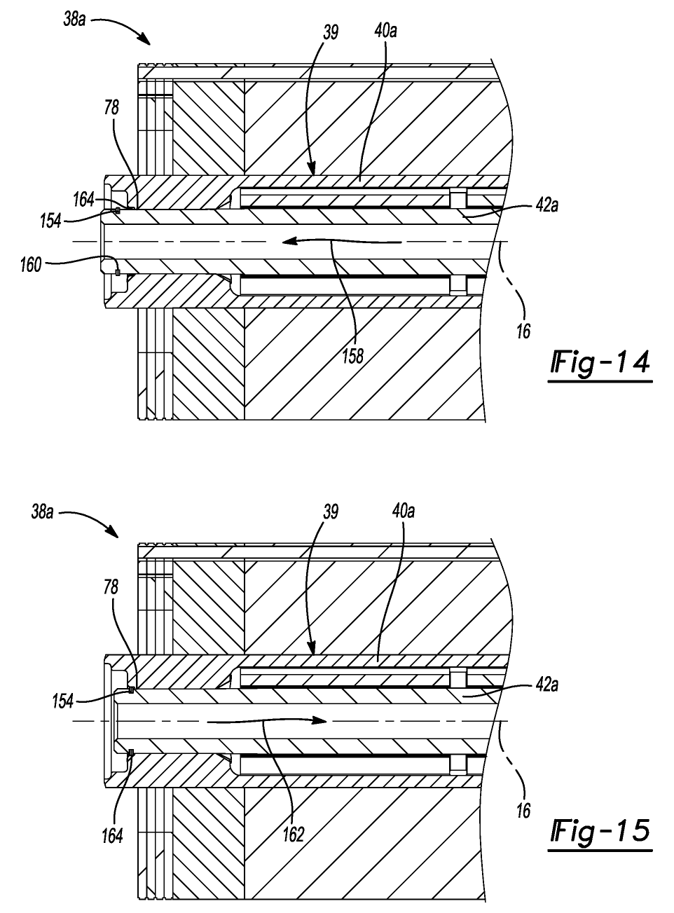

FIGS. 14-15 are cross-sectional views of the implementation of FIG. 13 showing the sequential steps in an assembly process. FIG. 14 shows a first step where the gear shaft 42a is in an install position after the shaft 42a has been inserted into the inner cavity 76 and pushed in a direction 158 past what will be the gear shaft’s final position. A retaining ring 154 is installed in a circumferential groove 160 formed in the gear shaft’s outer surface 78. The rotor shaft 40a also includes a bore 164.

FIG. 15 shows a final position of the gear shaft 42a after a second step has been performed, when the gear shaft 42a is pulled back in the direction 162 until the retaining ring 154 is received and seated in the bore 164 formed in a proximally-facing axial end of rotor shaft 40a. The retaining ring 154 may be a substantially flat ring. In an implementation, the retaining ring 154 may comprise steel.

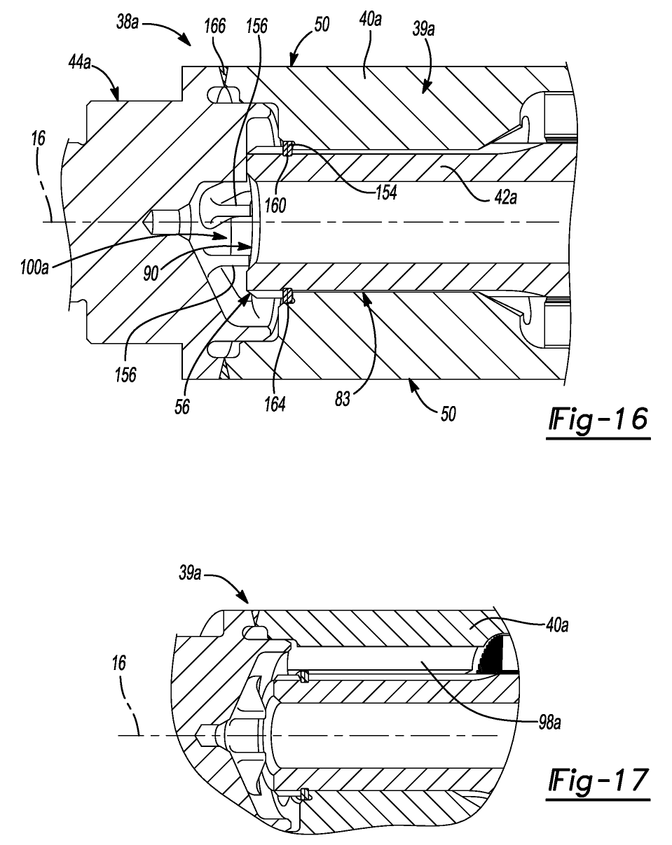

FIG. 16 shows an enlarged cross-sectional view of a portion of the rotor assembly 38a featuring rotor shaft system 39a. The end cap 44a has castellations 156 that extend in a distal direction through the duct 100a and engage the gear shaft 42a. The castellations 156 bear against the proximal end 56 but still allow oil to flow out of the opening 90 and to the passages 98a (FIG. 17). The end cap 44a may be fixedly connected (e.g., via a weld 166) to the rotor shaft 40a. In this implementation, the end cap 44a is configured to take axial gear shaft thrust forces in the proximal direction via the castellations 156 while the retaining ring 154 is configured to take the axial gear shaft thrust forces in the distal direction. The implementation is relatively fixed in that to separate the components requires cutting the weld 166 or shearing the retaining ring 154.

FIG. 17 is a cross-sectional view of the rotor shaft system 39a sectioned so as to show oil passage 98a.

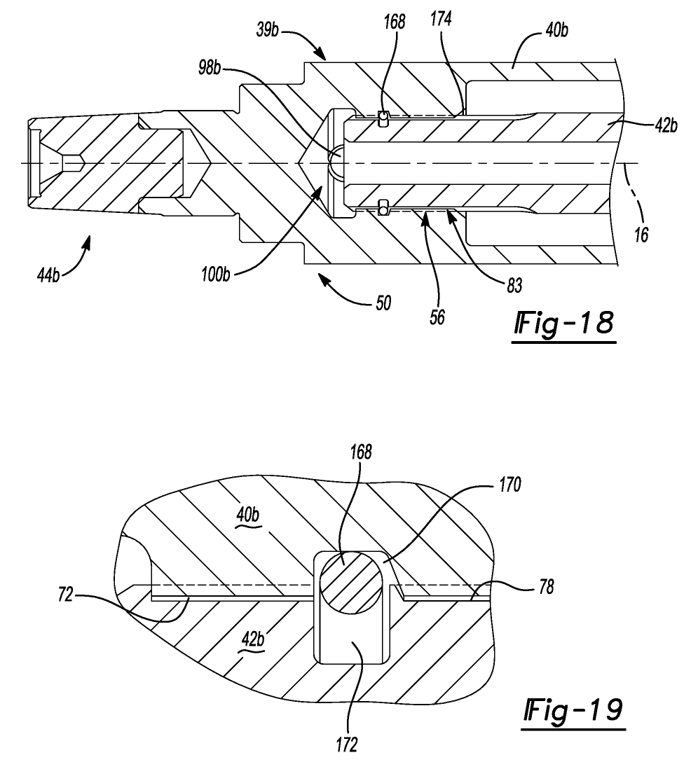

FIGS. 18-19 illustrate various views of a further alternate implementation of the rotor shaft system designated 39b, with portions omitted for clarity. Unless otherwise described and/or illustrated, the rotor shaft system 39b may be the same or similar to the rotor shaft systems 39/39a to the extent that the same or similar reference numerals (i.e., differing by only a suffix—a letter) identify the same or similar components in the various views. The rotor shaft system 39b may be used in the electric motor 14 of FIG. 2.

FIG. 18 is a cross-sectional view of a portion of the rotor shaft system 39b. In the rotor shaft system 39b, the connection of the gear shaft 42b to the rotor shaft 40b differs in that a retaining ring 168 is used instead of either the dowel pin 88/sleeve 94 arrangement or the retaining ring 154/castellations 156 arrangement, with various changes made to the rotor shaft 40b, the gear shaft 42b, and the end cap 44b as described and illustrated herein. In an implementation, the rotor shaft 40b is unitary and comprises is a blind hollow shaft (i.e., the hollow rotor shaft 40b is closed at its proximal end 50). Thus, the spline connection 83 and the oil circulation features (i.e., passages 98b) are blind. The end cap 44b comprises non-magnetic material, for example for the purpose of incorporating a magnet (not specifically shown) for implementations using a TMR speed sensor, as elaborated above in connection with the end cap 44. The end cap 44b is fixedly mounted to the extreme proximal end of the rotor shaft 40b.

FIG. 19 is a cross-sectional view of the retaining ring 168 of FIG. 18. The rotor shaft 40b has a circumferential groove 170 on the inside diameter surface 72 thereof at its proximal end 50. The gear shaft 42b has a circumferential groove 172 on the outer surface 78 at its proximal end 56. The retaining ring 168 upon installation resides in grooves 170, groove 172 to thereby axially align the gear shaft 42b to the rotor shaft 40b. The retaining ring 168 may comprise conventional wire ring component(s) known in the art. Prior to assembly, the retaining ring 168 is inserted into groove 172. During assembly, the gear shaft 42b is inserted into the interior 76 of the rotor shaft 40b and pushed in a direction toward the proximal end 50. When the gear shaft 42b is inserted far enough so that the splines on the gear shaft 42b begin to mate with the corresponding grooves, a ramp 174 engages and begins compressing the retaining ring 168. Upon further insertion of the gear shaft 42b, the retaining ring 168 springs into the groove 170. In implementations, the groove dimensions can be tailored for permanent assembly or removable assembly.

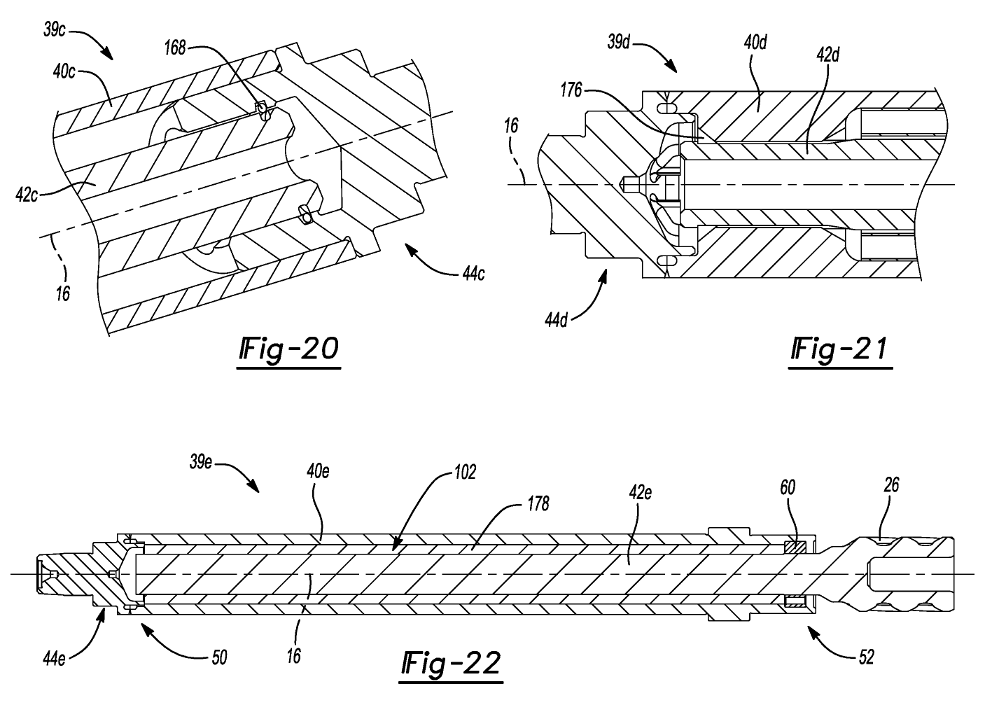

FIG. 20 is a cross-sectional view illustrating a still further alternate implementation of the rotor shaft system designated 39c, with portions omitted for clarity. Unless otherwise described and/or illustrated, the rotor shaft system 39c may be the same or similar to the rotor shaft systems 39/39a/39b to the extent that the same or similar reference numerals (i.e., differing by only a suffix—a letter) identify the same or similar components in the various views. The rotor shaft system 39c may be used in the electric motor 14 of FIG. 2.

In the rotor shaft system 39c, the connection of the gear shaft 42c to the rotor shaft 40c differs in that an end cap 44c is used instead of the connection arrangements described hereinbefore, with various changes made to the rotor shaft 40c, the gear shaft 42c, and the end cap 44c as described and illustrated herein. The end cap 44c has the drive feature (i.e., to rotate the gear shaft 42c) and the end cap 44c may be welded to the rotor shaft 40c. The end cap 44c has a blind spline and oil circulation features similar to the implementation of the rotor shaft in FIGS. 18-19. The other axial end of the gear shaft 42c (i.e., the axial end not shown in FIG. 20) has the drive gear 26.

FIG. 21 is a cross-sectional view illustrating a yet further alternate implementation of a rotor shaft system designated 39d, with portions omitted for clarity. Unless otherwise described and/or illustrated, the rotor shaft system 39d may be the same or similar to the rotor shaft systems 39/39a/39b/39c to the extent that the same or similar reference numerals (i.e., differing by only a suffix—a letter) identify the same or similar components in the various views. The rotor shaft system 39d may be used in the electric motor 14 of FIG. 2.

In the rotor shaft system 39d, the fixed connection of the gear shaft 42d to the rotor shaft 40d differs in that the shafts 40d, 42d are welded (at 176) instead of the connection arrangements described hereinbefore. This implementation is similar to the implementation of FIGS. 13-17 except that the retaining ring 154, the groove 160, and the bore 164 are not used. Additionally, the implementation of FIG. 21 may or may not include the spline connection 83.

FIG. 22 is a cross-sectional view illustrating a still yet further alternate implementation of a rotor shaft system designated 39e, with portions omitted for clarity. Unless otherwise described and/or illustrated, the rotor shaft system 39e may be the same or similar to the rotor shaft systems 39/39a/39b/39c/39d to the extent that the same or similar reference numerals (i.e., differing by only a suffix—a letter) identify the same or similar components in the various views. The rotor shaft system 39e may be used in the electric motor 14 of FIG. 2.

FIG. 22 shows an implementation where no oil circulation-based cooling is used. The gear shaft 42e may comprises a solid shaft. In the rotor shaft system 39e, the fixed connection of the gear shaft 42e to the rotor shaft 40e differs from the connection arrangements described hereinbefore in that an elastomeric material 178 disposed in and substantially filling the annular space 102 is used instead, with various changes made to the rotor shaft 40e, the gear shaft 42e, and the end cap 44e as described and illustrated. The elastomeric material 178, and thus the coupling of the rotor shaft 40e to the gear shaft 42e, axially extends in the annular space 102 from the proximal end 50 towards the distal end 52. The elastomeric material 178 may extend to the distal end opening less a distance corresponding to the axial length of the bushing 60. One or more the bushings 60 may be used to maintain the alignment of the drive gear 26 with one or more gears in the gearbox 18. In implementations, elastomeric material 178 may include, without loss of generality, materials such as rubber, rubber-like compounds, and/or compounds with molecules arranged in a manner so as to exhibit rubber-like properties.

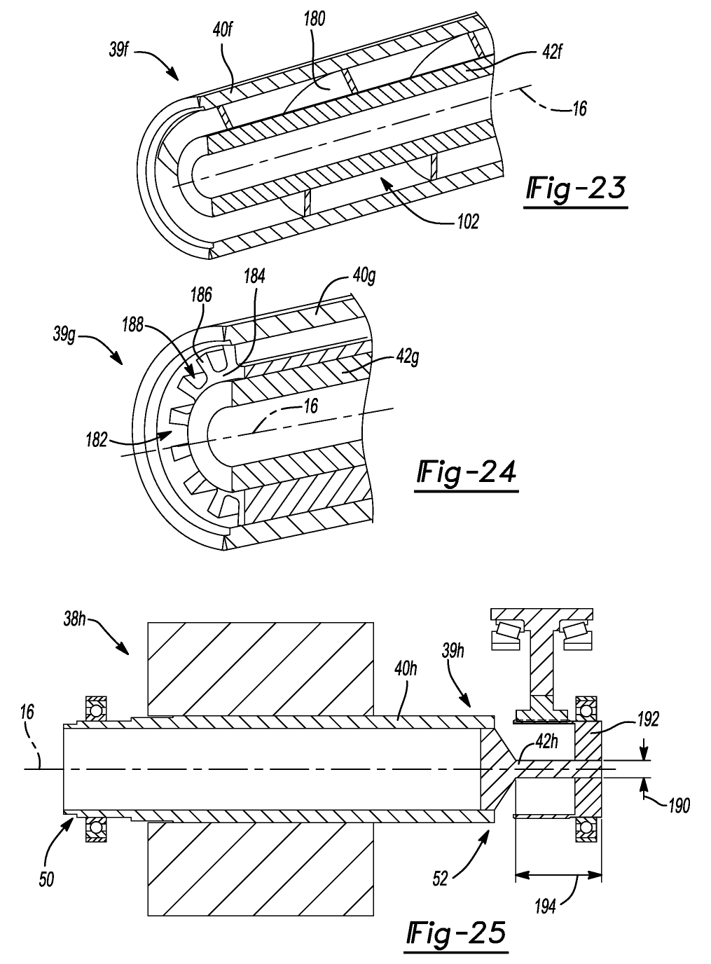

FIG. 23 is a cross-sectional view illustrating another alternate implementation of a rotor shaft system 39f, with portions omitted for clarity. Unless otherwise described and/or illustrated, the rotor shaft system 39f may be similar to the rotor shaft systems 39/39a/39b/39c/39d/39e with the same or similar reference numerals (i.e., differing by only a suffix—a letter) identifying the same or similar components in the various views. The rotor shaft system 39f may be used in the electric motor 14 of FIG. 2.

FIG. 23 also shows an implementation adapted to a situation where no oil circulation-based cooling is used, similar to the configuration shown in FIG. 22. The rotor shaft system 39f differs from rotor shaft system 39e in that the elastomeric material 178 takes the form of an elastomeric insert 180 in a helix or helical shape having a helix axis coincident with the axis 16, with various changes to the rotor shaft 40f and the gear shaft 42f as described and illustrated.

FIG. 24 is a cross-sectional view illustrating yet another alternate implementation of a rotor shaft system designated 39g, with portions omitted for clarity. Unless otherwise described and/or illustrated, the rotor shaft system 39g may be the same or similar to the rotor shaft systems 39/39a/39b/39c/39d/39e/39f to the extent that the same or similar reference numerals (i.e., differing by only a suffix—a letter) identify the same or similar components in the various views. The rotor shaft system 39g may be used in the electric motor 14 of FIG. 2.

FIG. 24 shows an implementation adapted to the situation where at least some amount of oil circulation-based cooling is needed or desired. The rotor shaft system 39g differs from rotor shaft system 39e in that the elastomeric material 178 takes the form of an elastomeric insert 182 having a starburst shape, with various changes to the rotor shaft 40g and the gear shaft 42g as described and illustrated. The insert 182 includes an annular body 184 and a plurality of radially-outwardly extending teeth 186 with intervening slots 188. The inside diameter of the annular body 184 corresponds to the outside diameter of the outer surface 78 of gear shaft 42g. The insert 182 is axially-extending with respect to the axis 16 and thus the teeth 186 and the slots 188 are also axially-extending. The axially-extending slots 188 form passages for carrying a flow of oil for cooling from one axial end to the other axial end of the gear shaft 42g.

FIG. 25 is a diagrammatic, cross-sectional view of still yet another alternate implementation of a rotor shaft system 39h, with portions omitted for clarity. Unless otherwise described and/or illustrated, the rotor shaft system 39h may be the same or similar to the rotor shaft systems 39/39a/39b/39c/39d/39e/39f/39g to the extent that the same or similar reference numerals (i.e., differing by only a suffix—a letter) identify the same or similar components in the various views. The rotor shaft system 39h may be used in the electric motor 14 of FIG. 2.

The rotor assembly 38h comprises the rotor shaft system 39h, which has a rotor shaft 40h and a stub shaft 42h. An end cap, although not shown in FIG. 25, may also be provided. In this implementation, the stub shaft 42h is fixedly coupled to the rotor shaft 40h at the distal end 52 such that the rotor shaft 40h and the stub shaft 42h rotate together. The stub shaft 42h has a first outside diameter at a point where it is connected to the rotor shaft 40h, which outside diameter corresponds to the diameter of the rotor shaft 40h at that point. The outside diameter (OD) of the stub shaft 42h transitions to a second outside diameter, designated 190, that is less that the first outside diameter. The OD transition of the stub shaft 42h results in a funnel shape. The stub shaft 42h axially extends along the axis 16 in a distal direction to a gear 192, where it is also fixedly connected such that the stub shaft 42h drives the gear 192 for rotation. The gear 192 can in turn drive other gears and/or torque transmitting mechanisms in the gearbox 18.

An extent of the length of the reduced OD portion of the stub shaft 42h, that portion having the reduced OD 190, is designated 194. In implementations, the outside diameter 190 may be 10 mm or 20 mm and the length 194 may be 50 mm or 100 mm (and combinations thereof). It should be understood that the values for the outside diameter 190 and the length 194 are exemplary only and not limiting in nature. The rotor shaft system 39h exhibits increased torsional compliance.

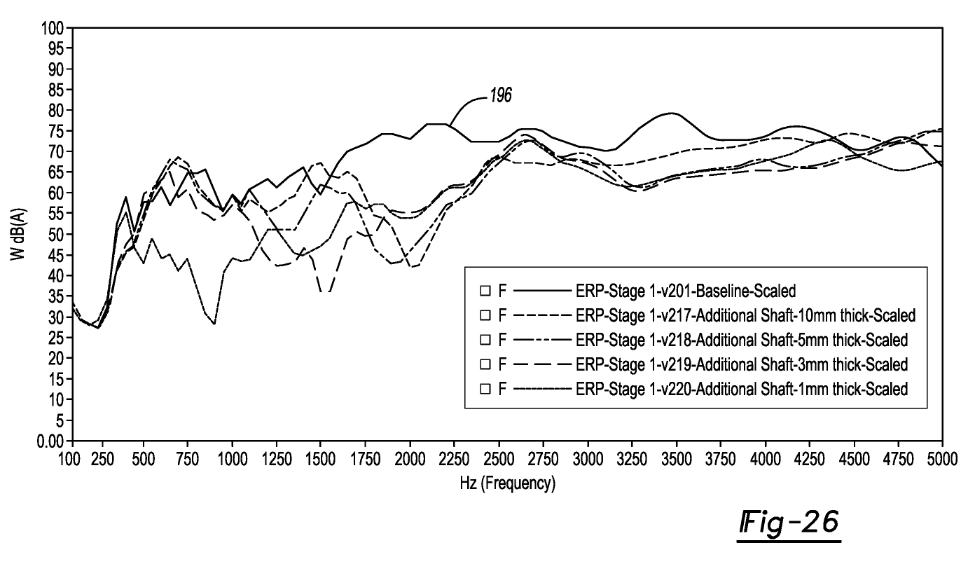

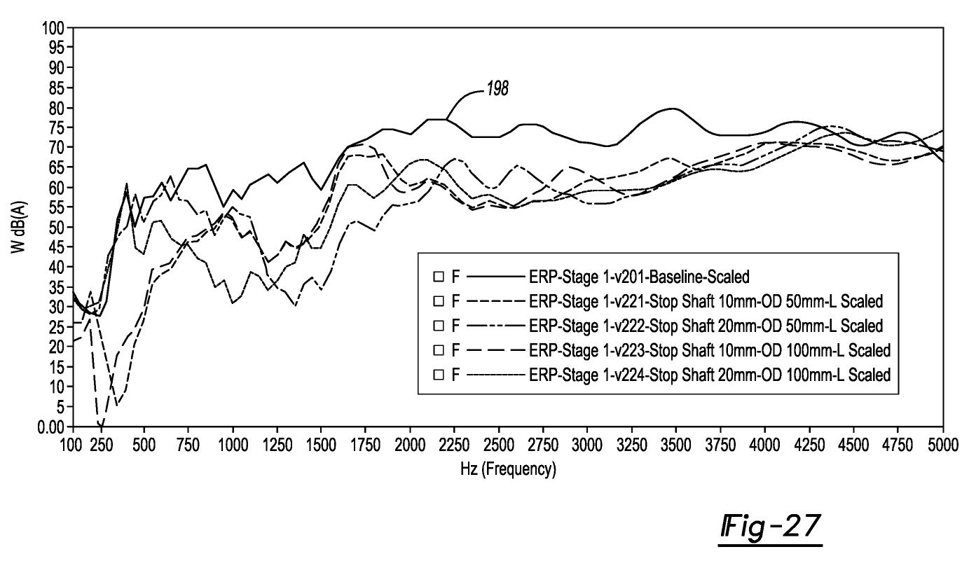

FIGS. 26-27 are plots showing respective reductions in Equivalent Sound Radiation Power (ERP) compared to respective baseline levels 196, 198 due to increased torsional compliance according to different embodiments. The X-axis indicates the frequency of interest (i.e., units of Hertz-Hz) while the Y-axis (ERP) is in units of sound power (i.e., watts-W). As shown in FIG. 26, implementations employing an extended shaft length approach exhibited reductions between about 10~15 dB across a wide frequency range as compared to the baseline level 196. As shown in FIG. 27, implementations employing a shaft OD reduction approach exhibited at least ~10 dB reduction for most of the 1000-3500 Hz range.

It should be understood that variations are possible. For example only, torsional compliance can be added on a non-rotor shaft in the gearbox, to couple two or more rotating shafts and/or gears.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. An electric motor drive system, comprising:
an electric motor having a stator and a rotor assembly, the rotor assembly having a rotor shaft system that includes:
a hollow rotor shaft, the rotor shaft extending along and configured to rotate about an axis, the rotor shaft including a rotor shaft sidewall defining an interior; and
a gear shaft concentrically received within the interior of the rotor shaft, the gear shaft having a gear shaft proximal end and a gear shaft distal end where a drive gear resides, the gear shaft proximal end that is axially opposite the drive gear is fixedly coupled to the rotor shaft such that the rotor shaft and the gear shaft rotate together.

2. The electric motor drive system of claim 1 further including a gearbox having an input configured for engagement with the drive gear, the gearbox further having an output.

3. The electric motor drive system of claim 1 wherein the rotor shaft has a rotor shaft proximal end and a rotor shaft distal end, the gear shaft being coupled to the rotor shaft at the rotor shaft proximal end.

4. The electric motor drive system of claim 3 wherein the gear shaft has a gear shaft outside diameter surface, wherein the gear shaft proximal end has a plurality of splines on the outside diameter surface, each spline residing in a corresponding groove in an inside diameter surface of the rotor shaft proximal end to thereby form a splined connection between the rotor shaft and the gear shaft.

5. The electric motor drive system of claim 4 wherein the rotor shaft system further comprises an end cap, and wherein the hollow rotor shaft includes a first opening at the rotor shaft proximal end wherein the end cap is configured to close the first opening.

6. The electric motor drive system of claim 5 wherein the gear shaft is a hollow gear shaft including a gear shaft sidewall defining an inner cavity, and wherein the rotor shaft system includes a cooling channel that fluidly couples an inlet port and an outlet port in a coolant flow path, and wherein the cooling channel includes
an axially-extending annular space between the rotor shaft inside diameter surface and an outer surface of the gear shaft,
the inner cavity of the gear shaft, and
a duct formed in the end cap configured that fluidly couples the annular space and the inner cavity, and wherein the inlet port is located at the distal end of the gear shaft and is in fluid communication with the inner cavity, the outlet port is located at the distal end of the rotor shaft and is in fluid communication with the annular space.

7. The electric motor drive system of claim 6 wherein the rotor shaft system further comprises a bushing disposed at the rotor shaft distal end that includes at least one axially-extending passageway therethrough to fluidly couple the outlet port with the annular space.

8. The electric motor drive system of claim 6 wherein the rotor shaft system further comprises a heat sink disposed in the annular space, the heat sink being in intimate contact with the inside diameter surface of the rotor shaft.

9. The electric motor drive system of claim 6 wherein the rotor shaft includes at least one passage at the gear shaft proximal end configured to fluidly couple the annular space with the inner cavity through the duct in the end cap.

10. The electric motor drive system of claim 4 wherein the rotor shaft system further comprises a dowel pin transversely extending through the rotor shaft and the gear shaft at respective proximal ends thereof.

11. The electric motor drive system of claim 6 wherein the rotor shaft sidewall has a rotor shaft outside diameter surface, the rotor shaft system further comprising a sleeve disposed on the rotor shaft outside diameter surface at the rotor shaft proximal end that is configured to retain the dowel pin in the rotor shaft.

12. The electric motor drive system of claim 11 wherein the end cap includes an annular body having a first end in which the duct is formed and which faces the first opening, the end cap further having a second end axially opposite the first end, the end cap further including a circumferential surface extending radially outwardly a first outside diameter to engage the sleeve, the end cap further including an annular surface having a second outside diameter and extending in an axially proximal direction relative to the circumferential surface wherein the second outside diameter is less than the first outside diameter, the end cap further including a bearing surface having a third outside diameter and extending in the axially proximal direction relative to annular surface wherein the third outside diameter is less than the second outside diameter, the end cap including a flat portion on the bearing surface, the sleeve extending axially over the circumferential surface and the annular surface, the sleeve including a through-hole over the annular surface, wherein the rotor shaft system includes an air passageway to allow rotor area air venting, the air passageway including the through-hole, a first air space outwardly of the annular surface, and a second air space proximate the flat.

13. The electric motor drive system of claim 5 wherein the rotor shaft system further comprises a retaining ring disposed in a groove in the gear shaft outside diameter surface at the gear shaft proximal end, the rotor shaft proximal end having a bore formed in a proximally-facing axial end configured to receive the retaining ring.

14. The electric motor drive system of claim 13 wherein the end cap includes castellations extending through the duct and engaging the gear shaft.

15. The electric motor drive system of claim 4 wherein the rotor shaft system further comprises a retaining ring, and wherein the hollow rotor shaft is closed at the rotor shaft proximal end and having a rotor shaft circumferential groove on the rotor shaft inside diameter surface at the rotor shaft proximal end, the gear shaft having a gear shaft circumferential groove on the gear shaft outside diameter surface at the gear shaft proximal end, the retaining ring being disposed in the rotor shaft circumferential groove and the gear shaft circumferential groove to thereby axially align the gear shaft to the rotor shaft.

16. The electric motor drive system of claim 15 wherein the gear shaft is a hollow gear shaft including a gear shaft sidewall defining an inner cavity, and wherein the rotor shaft system includes a cooling channel that fluidly couples an inlet port and an outlet port in a coolant flow path, and wherein the cooling channel includes
an axially-extending annular space between the rotor shaft inside diameter surface and an outer surface of the gear shaft,
the inner cavity of the gear shaft, and
a duct in the rotor shaft proximal end that opens toward the rotor shaft interior, the duct fluidly coupling the annular space and the inner cavity, and wherein the inlet port is located at the distal end of the gear shaft and is in fluid communication with the inner cavity, the outlet port is located at the distal end of the rotor shaft in fluid communication with the annular space.

17. The electric motor drive system of claim 16 wherein the rotor shaft includes at least one passage configured to fluidly couple the annular space with the inner cavity through the duct.

18. The electric motor drive system of claim 3 wherein the rotor shaft system further comprises an axially-extending annular space between the rotor shaft inside diameter surface and an outer surface of the gear shaft in which is disposed elastomeric material to couple the gear shaft to the rotor shaft, the elastomeric material axially extends from the rotor shaft proximal end towards the rotor shaft distal end.

19. The electric motor drive system of claim 18 wherein the elastomeric material has a shape selected from the group comprising a solid shape, a helix shape, and an annular body in a starburst shape with a plurality of teeth radially-outwardly extending from the annular body, the teeth separated by intervening slots wherein the slots form axially-extending passages.

20. The electric motor drive system of claim 1 wherein the rotor shaft system further comprises an end cap, and wherein the hollow rotor shaft includes a first opening at the rotor shaft proximal end wherein the end cap is configured to close the first opening, the gear shaft is fixedly coupled to the end cap, the end cap is fixedly coupled to the rotor shaft.

21. An electric motor drive system, comprising:
an electric motor having a stator and a rotor assembly, the rotor assembly having a rotor shaft system that includes:
a hollow rotor shaft, the rotor shaft axially extending along an axis between a rotor shaft proximal end and a rotor shaft distal end wherein the rotor shaft is configured to rotate about the axis, and
a stub shaft having an annular body axially extending between a stub shaft proximal end and a stub shaft distal end, the stub shaft proximal end being fixedly connected to the rotor shaft at the rotor shaft distal end such that the rotor shaft and the stub shaft rotate together, the stub shaft having a first outside diameter at the stub shaft proximal end and a second outside diameter at the stub shaft distal end, and wherein the second diameter is less than the first diameter.

22. The electric motor drive system of claim 21 further including a gearbox having an input configured for engagement with the stub shaft distal end, the gearbox further having an output.

23. The electric motor drive system of claim 22 wherein the stub shaft has a transition region where the first outside diameter transitions to the second outside diameter, the transition region comprising a funnel shape.

24. An electric motor drive system, comprising:
an electric motor having a stator and a rotor assembly, the rotor assembly having a rotor shaft system that includes a first shaft extending along an axis configured to rotate about the axis and having a proximal end and a distal end where a drive gear resides;
a transmission having an input driven by the drive gear and an output, the transmission having a plurality of second shafts and gears including a torsional shaft configured to couple at least two of the plurality of second shafts and gears.
